(19) United States
(12) Patent Application Publication
(10) Pub. No.: US 2023/0376799 A1
(43) Pub. Date: Nov. 23, 2023

(54) MACHINE LEARNING MODEL FOR RECOMMENDING INTERACTION PARTIES

(71) Applicant: Capital One Services, LLC, McLean, VA (US)

(72) Inventors: Samuel RAPOWITZ, Roswell, GA (US); Mohammadamin Dashti MOGHADDAM, Pleasant Hill, CA (US); Brian MCCLANAHAN, Silver Spring, MD (US); Victoria MARTINS, Pinole, CA (US); Ian KATZMAN, Herndon, VA (US)

(21) Appl. No.: 17/664,103

(22) Filed: May 19, 2022

(51) Int. Cl. G06N 5/04; G06N 5/02

(52) U.S. Cl. CPC G06N 5/04; G06N 5/022

(57) ABSTRACT

In some implementations, a system may receive an input indicating an interaction party identifier corresponding to a selected interaction party, wherein a geographic location may be associated with the interaction party identifier. The system may receive aspect preference data indicating one or more aspects to determine a similarity between the selected interaction party and one or more other interaction parties. The system may identify one or more identified interaction parties having geographic locations within a distance threshold of the geographic location associated with the interaction party identifier. The system may use a machine learning model to determine similarity scores for the one or more identified interaction parties based on one or more aspects associated with historical interactions with the one or more identified interaction parties. The system may transmit, to a user device, data indicating one or more similar interaction parties having similarity scores above a score threshold.

### BACKGROUND

Machine learning involves computers learning from data to perform tasks. Machine learning algorithms are used to train machine learning models based on sample data, known as “training data.” Once trained, machine learning models may be used to make predictions, decisions, or classifications relating to new observations. Machine learning algorithms may be used to train machine learning models for a wide variety of applications, including computer vision, natural language processing, financial applications, medical diagnosis, and/or information retrieval, among many other examples.

### SUMMARY

Some implementations described herein relate to a system for recommending interaction parties having similar aspects to an interaction party selected by a user. The system may include one or more memories and one or more processors communicatively coupled to the one or more memories. The one or more processors may be configured to receive, from a user device of the user, an input indicating an interaction party identifier corresponding to a selected interaction party, wherein a geographic location is associated with the interaction party identifier. The one or more processors may be configured to receive, from the user device, aspect preference data indicating one or more selections corresponding to one or more aspects to determine a similarity between the selected interaction party and one or more other interaction parties. The one or more processors may be configured to identify one or more identified interaction parties having geographic locations within a distance threshold of the geographic location associated with the interaction party identifier. The one or more processors may be configured to use a machine learning model, which was trained to determine a similarity score for a particular interaction party based on historical training data, to determine similarity scores for the one or more identified interaction parties based on one or more aspects associated with historical interaction data corresponding to historical interactions with the one or more identified interaction parties. The one or more processors may be configured to transmit, to the user device, data indicating one or more similar interaction parties, of the one or more identified interaction parties, having similarity scores above a score threshold. The one or more processors may be configured to update the machine learning model based on feedback data received from the user device.

Some implementations described herein relate to a method of recommending interaction parties having similar aspects to an interaction party selected by a user. The method may include identifying, by a system that includes at least one processor and from historical interaction data of a user stored in a database, a selected interaction party from a historical interaction by the user. The method may include determining, by the system, a geographic location associated with a user device of the user. The method may include identifying, by the system, one or more identified interaction parties having geographic locations within a distance threshold of the geographic location associated with the user device of the user. The method may include determining, by the system, similarity scores for the one or more identified interaction parties, wherein the similarity scores are based at least in part on the one or more aspects. The method may include transmitting, by the system and to the user device, data indicating one or more similar interaction parties, of the one or more identified interaction parties, having similarity scores above a score threshold.

Some implementations described herein relate to a non-transitory computer-readable medium that stores a set of instructions for a device. The set of instructions, when executed by one or more processors of the device, may cause the device to receive, from a user device of a user, an input indicating an interaction party identifier corresponding to a selected interaction party, wherein a geographic location is associated with the interaction party identifier. The set of instructions, when executed by one or more processors of the device, may cause the device to receive, from the user device, aspect preference data indicating one or more selections corresponding to one or more aspects to determine a similarity between the selected interaction party and one or more other interaction parties. The set of instructions, when executed by one or more processors of the device, may cause the device to identify one or more identified interaction parties having geographic locations within a distance threshold of the geographic location associated with the interaction party identifier. The set of instructions, when executed by one or more processors of the device, may cause the device to determine similarity scores for the one or more identified interaction parties, wherein the similarity scores are based on the one or more aspects. The set of instructions, when executed by one or more processors of the device, may cause the device to transmit, to the user device, data indicating one or more similar interaction parties, of the one or more identified interaction parties, having similarity scores above a score threshold.

### BRIEF DESCRIPTION OF THE DRAWINGS

FIGS. 1A and 1B are diagrams of an example implementation relating to recommending interaction parties, in accordance with some embodiments of the present disclosure.

FIGS. 2A and 2B are diagrams of an example implementation relating to recommending interaction parties, in accordance with some embodiments of the present disclosure.

FIG. 3 is a diagram illustrating an example of training and using a machine learning model in connection with recommending interaction parties, in accordance with some embodiments of the present disclosure.

FIG. 4 is a diagram of an example environment in which systems and/or methods described herein may be implemented, in accordance with some embodiments of the present disclosure.

FIG. 5 is a diagram of example components of one or more devices of FIG. 4, in accordance with some embodiments of the present disclosure.

FIG. 6 is a flowchart of an example process relating to recommending interaction parties, in accordance with some embodiments of the present disclosure.

### DETAILED DESCRIPTION

The following detailed description of example implementations refers to the accompanying drawings. The same reference numbers in different drawings may identify the same or similar elements.

A user may interact with different interaction parties (e.g., peers, merchants, vendors, service providers, or restaurants) in different types of interactions (e.g., peer-to-peer file sharing, transactions). The interactions may be based on the user's personal preferences, the user's schedule, or by random. The user may have a positive experience with a particular interaction party and may continue to interact with the particular interaction party. However, the user also may desire to experience other interaction parties that may provide a similar type of positive experience. For example, the user may enjoy an experience at a particular restaurant of a particular cuisine, and the user may desire to have a similar experience with a similar type of restaurant but of a different cuisine. As another example, the user may be or plan on being in a geographic location with which the user is unfamiliar, but the user may want to find an interaction party that may provide a similar positive experience as the particular interaction party with which the user has interacted and may be continuing to interact.

However, the user may have to invest substantial time to research different interaction parties, for example, by reading through various reviews of multiple interaction parties. Such time may require excess computing resources, both of the user device and of a system from which the user is searching to perform the research. In addition to the amount of time to do so, the user may be limited in the information available to the user to be able to find another interaction party that closely resembles the particular interaction party to the user's satisfaction. For example, the user may not have customer/user information and/or sales information of the interaction parties. Additionally, the user may not know with a high level of certainty that the reviews that the user is reading are from other users having similar preferences as the user.

Furthermore, existing recommendation systems may base recommendations on the user's interaction history. However, the interaction history may not be indicative of the user's preferences and/or interests at the time that the recommendations are made. Additionally, the interaction history may involve a wide variety of types of interaction parties. As a result, the existing recommendation systems may have to provide recommendations for each of the wide variety of types. Alternatively, the existing recommendation systems may make recommendations directed to a specific type of interaction party, which may not be a type in which the user may be interested. Therefore, the existing recommendation systems may need to provide recommendations for different types of interaction parties until a specific type matches the user's interests at the time. In either scenario, the system inefficiently uses computing resources to determine and provide recommendations.

Accordingly, it is desirable to have a system that may recommend interaction parties to the user with a higher level of certainty that the user will positively receive the recommended similar interaction parties. As a result, the system may provide recommendations with a high level of efficiency, which may conserve time and computing resources.

Some implementations described herein may enable a recommendation system to provide recommendations of interaction parties to a user that are similar to an interaction party with which the user has had a positive experience. The recommendation system may use such an interaction party (e.g., as selected by the user or as identified from historical interactions of the user) as a base interaction party to identify and recommend the similar parties. The recommendation system may compare a group of identified interaction parties (e.g., interaction parties within a similar geographic region as the base interaction party or within a geographic region identified by the user) based on one or more aspects associated with the interaction parties (e.g., average interaction amounts, number of common users, environmental characteristics, reviews, and/or business categories). The user may select which aspects are important to the user, and therefore, which aspects the recommendation system is to use in the comparison. The recommendation system may determine a similarity score for each of the identified interaction parties based on the one or more aspects. Metrics associated with the one or more aspects and used to determine the similarity scores may be obtained from various sources, including one or more databases associated with the interaction parties and/or historical interactions of the user and/or other users, and from a device of the user and/or other users (e.g., when the user and/or other users are interacting with a particular interaction party). The processing system may identify the identified interaction parties having similarity scores above a score threshold as similar interaction parties to the base interaction party and may provide a list of the similar interaction parties to the user. In some implementations, the similarity scores and/or the determination of similar interaction parties may be performed by a machine learning model.

By relying on actual metrics and based on user-provided preferences (e.g., the selected aspects), the recommendation system is able to efficiently provide recommendations of similar interaction parties to the user with a high level of certainty that the user will have a positive experience with the similar interaction parties. As a result, computer resources needed to perform multiple searches (e.g., by the user) of similar interaction parties may be conserved.

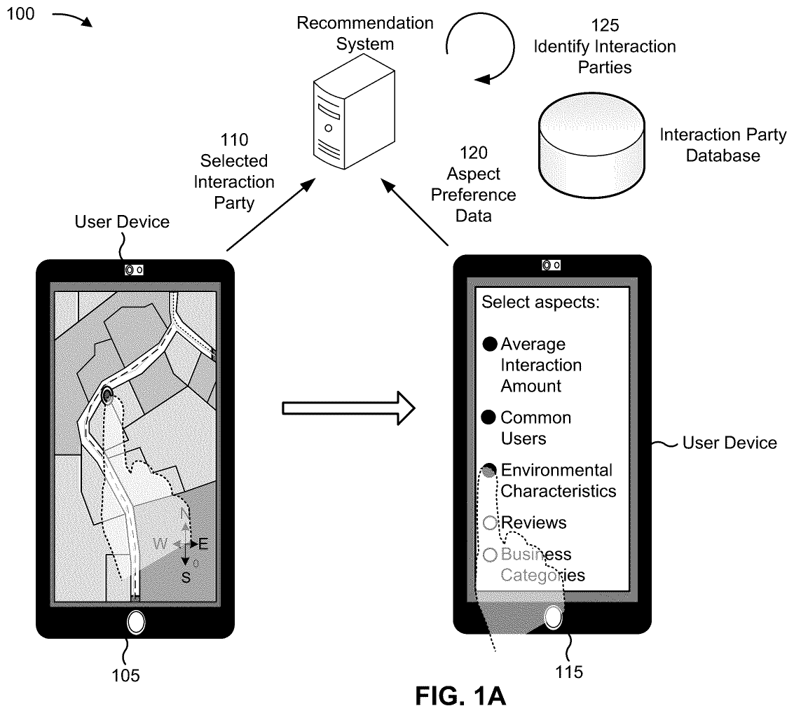

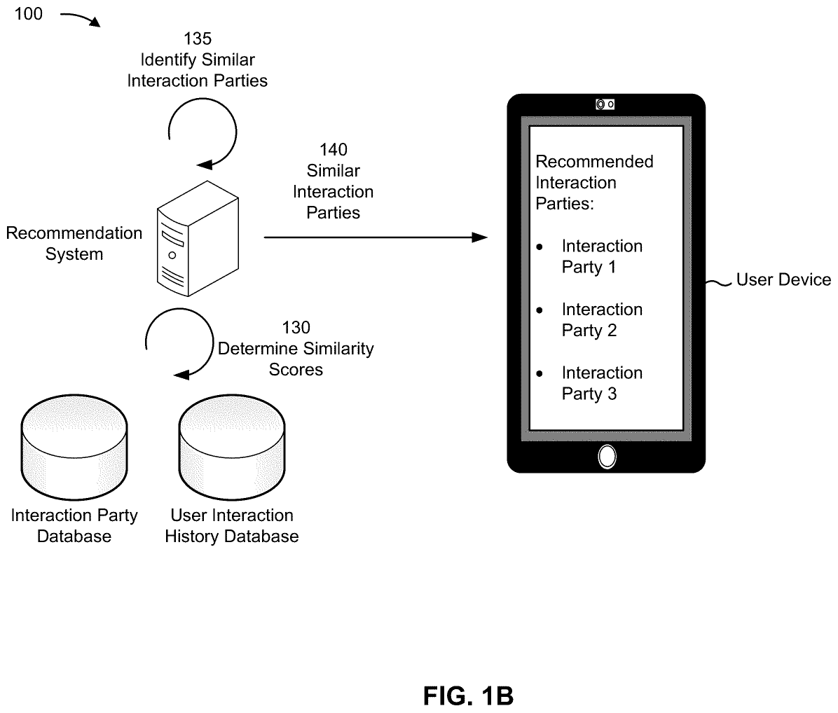

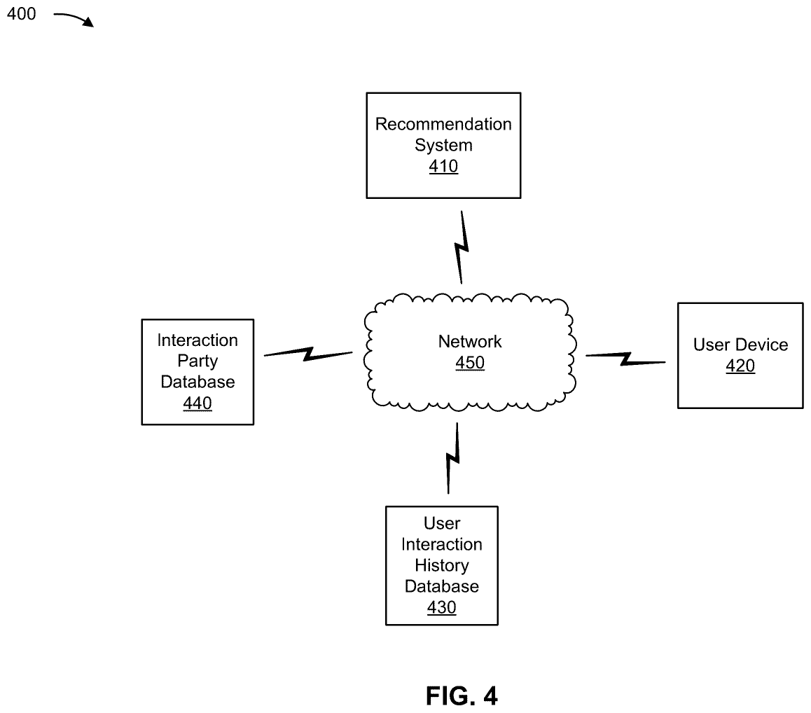

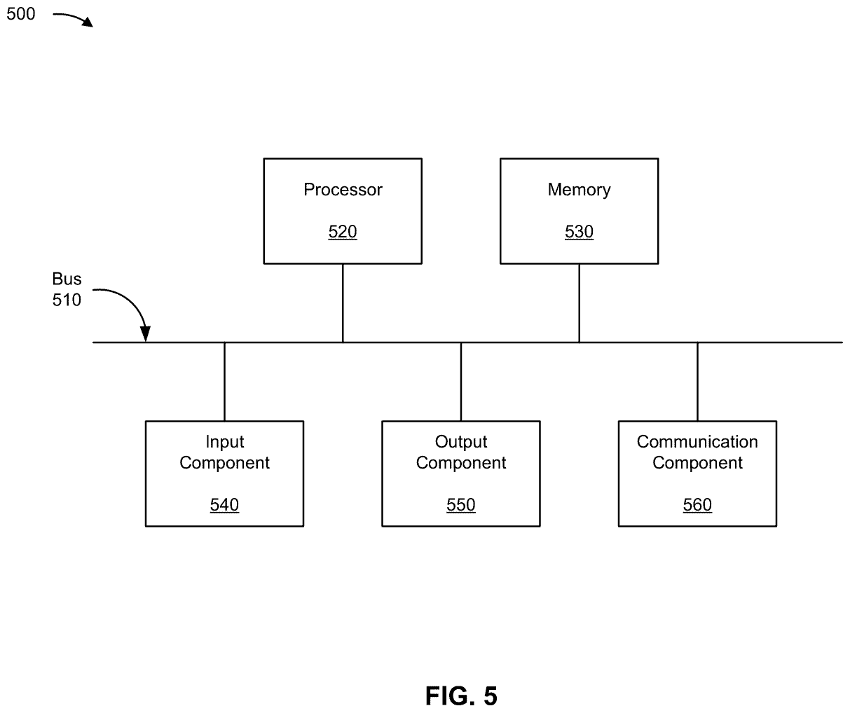

FIGS. 1A and 1B are diagrams of an example 100 associated with recommending interaction parties. As shown in FIGS. 1A and 1B, example 100 includes a recommendation system, a user device, a user interaction history database, and an interaction party database. These devices are described in more detail in connection with FIGS. 4 and 5.

As shown in FIG. 1A, the user device may receive, from a user, and the user may transmit, to the recommendation system, an input of an interaction party identifier corresponding to an interaction party (e.g., a merchant, a vendor, a service provider, or a restaurant) (also referred to as the selected interaction party) for which the user desires to have similar interaction parties recommended. For example, as shown by reference number 105, a map may be presented on a display of the user device. The user device, via user interaction from the user, may navigate the map, and may receive, from the user, a selection of a particular interaction party as the selected interaction party (e.g., via a touch-based interaction, by the user on a touchscreen of the user device, with an icon or other indicator representing the interaction party on the map). Alternatively, the user device may receive, from the user, a manual input of the name of the selected interaction party (e.g., in a dedicated entry field presented on the display of the user device and/or via a selection of the name, such as from a list populated on the display of the user device). As shown by reference number 110, the user device may transmit, and the recommendation system may receive, data indicating the interaction party identifier of the selected interaction party. The data also may indicate a geographic location (e.g., geographic coordinates) associated with the selected interaction party.

In some implementations, the recommendation system may determine similar interaction parties, from a plurality of interaction parties, to recommend to the user based on similarities between one or more aspects associated with the plurality of interaction parties and with the selected interaction party. One exemplary aspect may be respective average interaction amounts of the plurality of interaction parties and the selected interaction party (e.g., amounts associated with interactions of the interaction parties, such as average costs associated with the interactions and/or average number of units and/or items sold). Another exemplary aspect may be a quantity of users common to the selected interaction party and the plurality of interaction parties. Another exemplary aspect may be environmental characteristics (e.g., business traffic, noise level, or lighting) associated with respective physical locations of the plurality of interactions and the selected interaction party. Another exemplary aspect may be respective reviews of the plurality of interaction parties and the selected interaction party. Another exemplary aspect may be categories (e.g., business categories or interaction party types) associated with the plurality of interaction parties and the selected interaction party. As shown by reference number 115, the user device may receive, from the user, selections of which aspects are important to the user (e.g., from a list displayed on the display of the user device, as shown in FIG. 1A). As shown by reference number 120, the recommendation system may receive, from the user device, aspect preference data indicating the aspects selected and preferred by the user to be used in determining the similar interaction parties.

As shown by reference number 125, the recommendation system may identify interaction parties (e.g., from an interaction party database) to be included in the plurality of interaction parties from which the similar interaction parties to be recommended may be determined. For example, the recommendation system may identify the plurality of interaction parties (also referred to as identified interaction parties) based on the geographic location of the selected interaction party (e.g., interaction parties within a distance threshold from a geographic location of the selected interaction party). The user may be able to select and/or input the distance threshold (e.g., a 5 mile radius, a 10 mile radius, or a 50 mile radius). Alternatively, the user may be able to specify a specified location (e.g., geographic coordinates and/or zip code) in which the identified interaction parties are to be identified. Additionally, the user may be able to select and/or input a distance threshold (e.g., a 5 mile radius, a 10 mile radius, or a 50 mile radius) from the specified location.

As shown in FIG. 1B and by reference number 130, the recommendation system may determine similarity scores (also referred to as overall similarity scores) for the identified interaction parties based on the one or more aspects selected by the user. Aspect similarity scores may be determined for each aspect. If only one aspect is considered, then the overall similarity scores for the identified interaction parties may be the aspect similarity scores for the particular aspect.

As an example, for the aspect of average interaction amounts, the recommendation system may obtain interaction data associated with the identified interaction parties (e.g., from an interaction party database). The interaction data may indicate the average interaction amounts. Alternatively, the interaction data may indicate interaction amounts associated with at least a subset of historical interactions of the identified interaction parties, from which the recommendation system may determine the average interaction amounts. Additionally, or alternatively, the recommendation system may access interaction data corresponding to historical interactions of the user and/or other users with the identified interaction parties, where the interaction data may indicate interaction amounts for the historical interactions, from which the recommendation system may determine the average interaction amounts. To determine the aspect similarity scores, the recommendation system may determine differences between the average interaction amount of the selected interaction party and the average interaction amounts of the identified interaction parties. The aspect similarity scores may be the differences and/or the absolute values of the differences.

As another example, for an aspect of number of common users, the recommendation system may identify the users that have historical interactions with the selected interaction party and one or more of the identified interaction parties. For example, the recommendation system may access and/or obtain, from the user historical interaction database, records of historical interactions of the user and/or other users. The aspect similarity scores may be determined by one or more different comparison measures, such as a Jaccard similarity measure or a cosine similarity measure, based on the common users. For example, the recommendation system may identify a shared number corresponding to one or more of the users having interactions with the selected interaction party and one or more of the identified interaction parties. The recommendation system may also identify, from the plurality of records of the historical interactions, a total number of users having interactions with either of the selected interaction party and one or more of the identified interaction parties. The aspect similarity scores may be based on a comparison of the shared number and the total number.

As another example, for an aspect of environmental characteristics, the recommendation system may obtain measures corresponding to the particular environmental characteristics. For example, if the environmental characteristics include noise level, then the recommendation system may obtain decibel levels at the location of the selected interaction party and the venues of the identified interaction parties. In some implementations, the decibel levels may be received by the recommendation system from the user device of the user and/or other users that may measure the decibel level (e.g., via a microphone in the user device) while the user(s) are at the particular locations. The measured decibel levels may be averaged across all measured data points. Alternatively, the recommendation system may use only the decibel levels measured at a time of day or within a time range of day and/or a particular day (e.g., day of the week or in the year) that the user would most likely interact with the particular interaction parties (which may be determined as provided by the user as an input, or alternatively, determined from interaction data from the user's historical interactions, such as with the selected interaction party). The aspect similarity scores may be based on a comparison of the measured decibel levels associated with the identified interaction parties and with the selected interaction party (e.g., a difference between the respective decibel levels). Additionally, or alternatively, the recommendation system may apply a statistical measure or model to the collected data. For example, the recommendation system may apply a Kullback Leibler Divergence or a Rényi Divergence between power spectral densities produced from audio samples collected at the venues of the interaction parties. Such an approach may allow the frequency content of the venues to be considered and/or compared.

Additionally, or alternatively, if the environmental characteristics include lighting, then the recommendation system may obtain light levels (e.g., lumens, candelas, footcandles, and/or lux), for example, from a camera of the user device(s). As with the noise level, the measured light levels may be averaged across all measured data points, or alternatively, the recommendation system may use a subset of the data points measured at a time of day or within a time range of day and/or on a day (e.g., day of the week or in the year) that the user would most likely interact with the particular interaction parties. The aspect similarity scores may be based on a comparison of the measured light levels associated with the identified interaction parties and with the selected interaction party (e.g., a difference between the respective light levels). Additionally, or alternatively, the recommendation system may apply a statistical measure or model (e.g., Kullback Leibler Divergence or Rényi Divergence) to the collected data, which may be the same as or different from the statistical measure or model used for other environmental characteristics, such as noise level.

Additionally, or alternatively, if the environmental characteristics include business traffic (e.g., how crowded the venues for the interaction parties are or how much business the interaction party has), then the recommendation system may measure the business traffic based on the number of interactions of the interaction parties. The number of interactions may be averaged across an entire day, or alternatively, may be averaged across a specific time frame in the day at which the user is most likely to interact with the particular interaction parties. Additionally, the number of interactions may be further refined by the day or days of the week (e.g., a particular day, weekdays, or the weekend) and/or a specific time of year (e.g., fall, winter, spring, or summer) during which the user is most likely to interact with the particular interaction parties. The aspect similarity scores may be based on a comparison of the measured traffic associated with the selected interaction party and the identified interaction parties. Additionally, or alternatively, distributions of interaction times can be compared using a statistical measure (e.g., Kullback Leibler Divergence or Rényi Divergence), which may allow a distinction to be made between interaction parties having different levels of traffic at different times of day (e.g., one interaction party receiving more traffic in the morning, and another interaction party receiving more traffic in the evening).

The measurements associated with the environmental characteristics (e.g., light levels, noise levels, and/or traffic) may be stored and associated with the interaction parties (e.g., in the interaction party database). Accordingly, the recommendation system may obtain one or more measurements of environmental characteristics associated with one or more interaction parties from the interaction party database when determining aspect similarity scores.

As another example, for an aspect of reviews (e.g., user reviews and/or third or non-interacting party reviews), the aspect similarity score may be determined based on similarities in the reviews (e.g., the words in the reviews). To do so, the processing system may employ a word or natural language processing technique and/or algorithm to process and learn associations of words in the reviews (e.g., uses a neural network model, such as word2vec to learn word associations from a large corpus of text). Then, the processing system may apply one or more different comparison measures, such as a cosine similarity measure, to determine similarities between the reviews associated with the selected interaction party and the identified interaction parties.

Additionally, or alternatively, the identified interaction parties and the selected interaction parties may be associated with one or more categories and/or interaction party types (e.g., restaurant, travel, retail, grocery, home improvement, or entertainment). The categories or interaction party types may be associated with the interaction parties in a database, such as the interaction party database. The processing system may refine the identified interaction parties based on categories common to one or more of the interaction parties and the selected interaction party.

In scenarios in which multiple aspects are used, the aspect similarity scores may be normalized to be on the same numeric scale (e.g., 0-1, 0-10, or 0-100). The normalized aspect similarity scores may then be averaged to determine the overall similarity scores for the identified interaction parties.

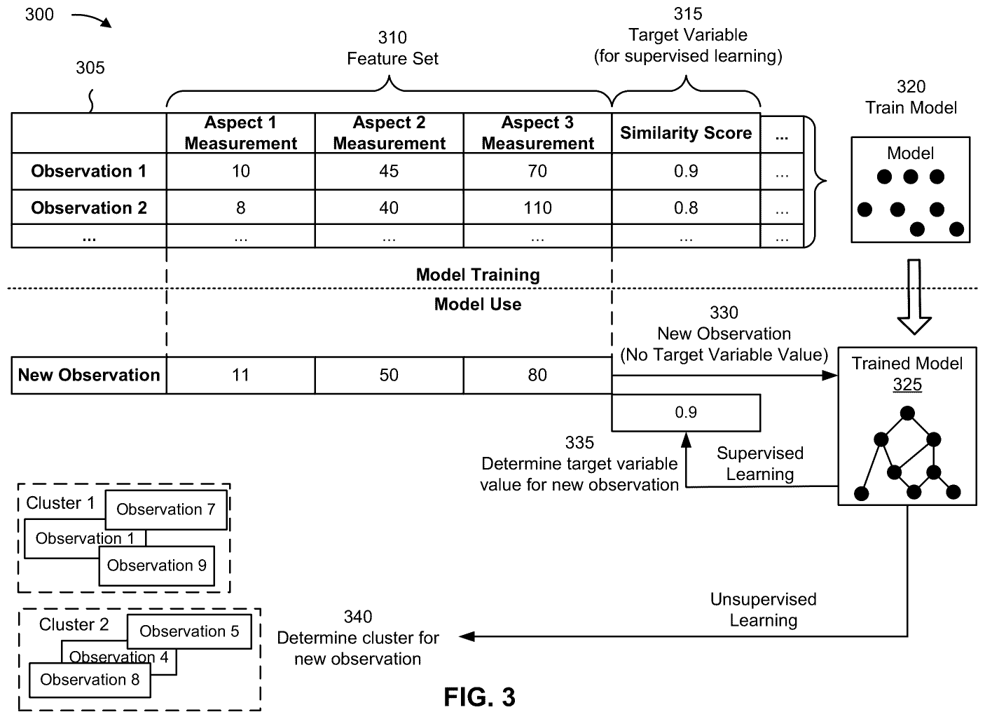

In some implementations, the recommendation system may use a machine learning model to determine the similarity scores of the plurality of interaction parties. The machine learning model may be trained to determine a similarity score for a particular interaction party, for each aspect and/or overall, based on historical training data, to determine the similarity scores of the plurality of interaction parties, as described in more detail below in connection with FIG. 3. The recommendation system may update the machine learning model based on feedback data (e.g., received from the user device).

As shown by reference number 135, the processing system may identify one or more similar interaction parties, of the identified interaction parties, to recommend to the user based on the similarity scores (e.g., overall similarity scores). For example, the processing system may identify the similar interaction parties as the interaction parties having similarity scores above a score threshold. As shown by reference number 140, the recommendation system may transmit data indicating the one or more similar interaction parties, which the user device may present on a display of the user device.

As described above, the recommendation system is able to determine and recommend to the user one or more similar interaction parties that are similar to a selected interaction party identified by the user by analyzing metrics associated with one or more aspects related to the interaction parties. By relying on such metrics, the recommendation system is able to provide recommendations of similar interaction parties to the user with a high level of certainty that the user will have a positive experience with the similar interaction parties. As a result, computer resources needed to perform multiple searches (e.g., by the user) of similar interaction parties may be conserved.

As indicated above, FIGS. 1A and 1B are provided as an example. Other examples may differ from what is described with regard to FIGS. 1A and 1B.

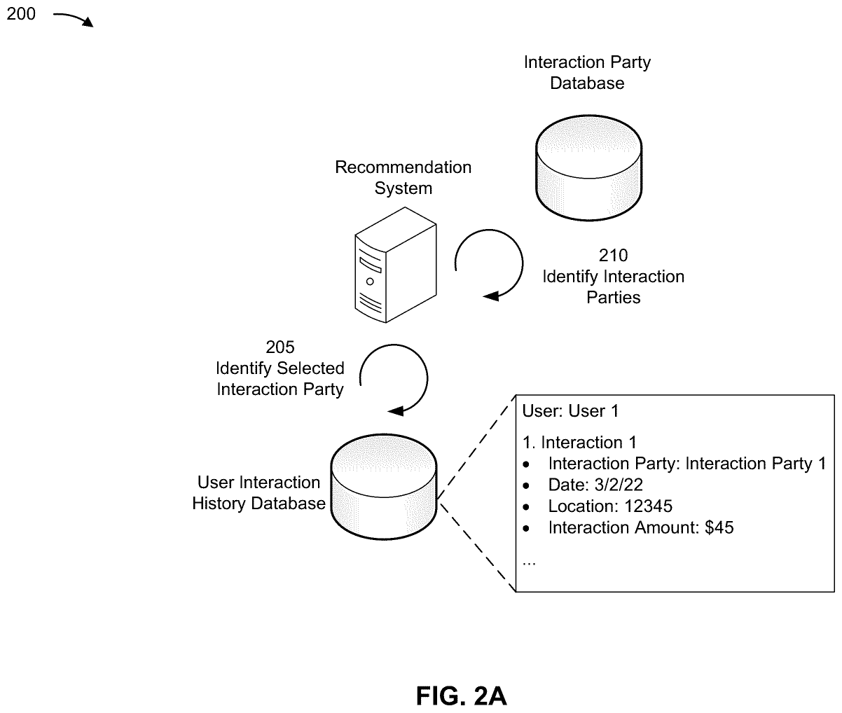

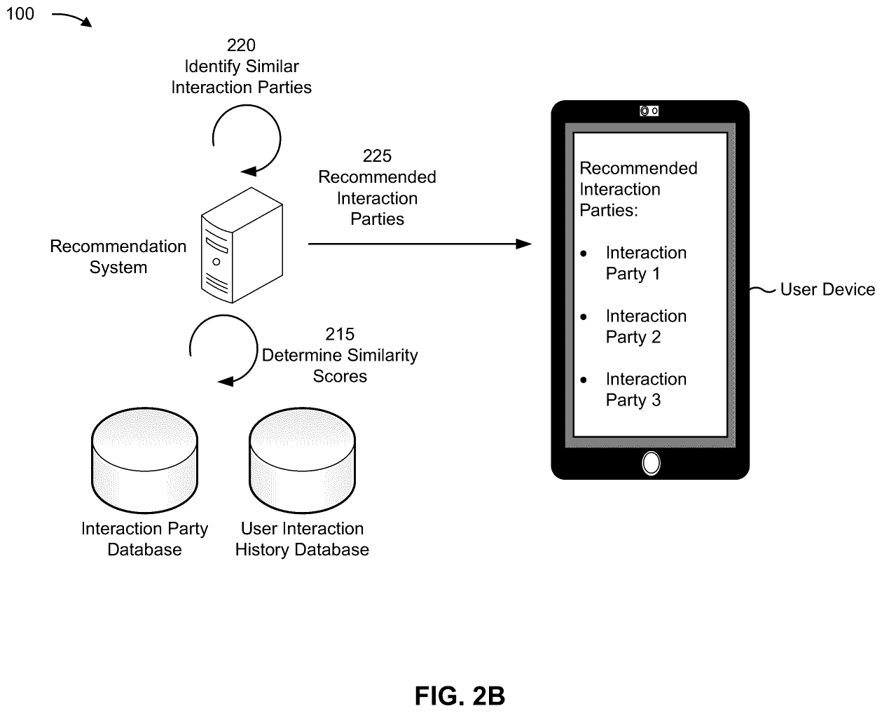

FIGS. 2A and 2B are diagrams of an example 200 associated with recommending interaction parties. As shown in FIGS. 2A and 2B, example 200 includes a recommendation system, a user interaction history database, an interaction party database, and a user device. These devices are described in more detail in connection with FIGS. 4 and 5.

As shown in FIG. 2A and by reference number 205, the recommendation system may identify an interaction party (also referred to as the selected interaction party) for which the recommendation system is to recommend similar interaction parties to the user. The recommendation system may automatically identify the selected interaction party (e.g., without user input) based on the user's interaction history of historical interactions, records for which may be stored on the user interaction history database. As shown in FIG. 2A, the records of the historical interactions may include information associated with the interactions, such as the interaction party with which a particular interaction was, a date on which the particular interaction occurred, a time (e.g., a timestamp) at which the particular interaction occurred, a location (e.g., a zip code and/or geographic coordinates) at which the particular interaction occurred, and/or an interaction amount associated with the particular interaction.

The recommendation system may identify the selected interaction party based on one or more factors and/or conditions associated with the historical interactions and/or the user. For example, the recommendation system may access and use historical interactions that occurred within a set time threshold (e.g., in the past month, the past 6 months, or the past year). Alternatively, the recommendation system may access historical interactions that occurred in a similar time of year (e.g., fall, winter, spring, or summer), day of the week (e.g., weekday or weekend), and/or time of day (e.g., morning, afternoon, or evening) as the current day and time. Additionally, or alternatively, the recommendation system may determine a number of interactions with each interaction party in the historical interactions and may identify the interaction party with the highest number of interactions as the selected interaction party. Additionally, or alternatively, the recommendation system may identify the interaction party having a highest interaction amount as the selected interaction party.

As shown by reference number 210, the recommendation system may identify interaction parties (e.g., from the interaction party database) to be included in the plurality of interaction parties from which the similar interaction parties to be recommended may be determined. For example, the recommendation system may identify the plurality of interaction parties (also referred to as identified interaction parties) based on the geographic location of the selected interaction party (e.g., interaction parties within a distance threshold from a geographic location of the selected interaction party).

As shown in FIG. 2B and by reference number 215, the recommendation system may determine similarity scores for the identified interaction parties based on the one or more aspects. The recommendation system may use all of the aspects or may use aspects previously selected by the user. The similarity scores may be determined in a similar manner as with example 100 and described above in connection with reference number 125. As shown by reference number 220, the processing system may identify one or more similar interaction parties, of the identified interaction parties, to recommend to the user based on the similarity scores (e.g., overall similarity scores). For example, the processing system may identify the similar interaction parties as the interaction parties having similarity scores above a score threshold. As shown by reference number 225, the recommendation system may transmit data indicating the one or more similar interaction parties, which the user device may present on a display of the user device.

As described above, the recommendation system is able to determine and recommend to the user one or more similar interaction parties based on the user's interaction history and without any input required by the user by analyzing metrics associated with one or more aspects related to the interaction parties. By relying on such metrics, the recommendation system is able to provide recommendations of similar interaction parties to the user with a high level of certainty that the user will have a positive experience with the similar interaction parties. As a result, computer resources needed to perform multiple searches (e.g., by the user) of similar interaction parties may be conserved.

As indicated above, FIGS. 2A and 2B are provided as an example. Other examples may differ from what is described with regard to FIGS. 2A and 2B.

FIG. 3 is a diagram illustrating an example 300 of training and using a machine learning model in connection with recommending interaction parties. The machine learning model training and usage described herein may be performed using a machine learning system. The machine learning system may include or may be included in a computing device, a server, a cloud computing environment, or the like, such as the recommendation system described in more detail elsewhere herein.

As shown by reference number 305, a machine learning model may be trained using a set of observations. The set of observations may be obtained from training data (e.g., historical data), such as data gathered during one or more processes described herein. In some implementations, the machine learning system may receive the set of observations (e.g., as input) from the user device, the user interaction history database, and/or the interaction party database, as described elsewhere herein.

As shown by reference number 310, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the user device, the user interaction history database, and/or the interaction party database. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of a measurement or a similarity score of a first aspect (e.g., average interaction amount of a particular interaction party), a second feature of a measurement or a similarity score of a second aspect (e.g., number of common users between the particular interaction party and the selected interaction party), a third feature of a measurement or a similarity score of a third aspect (e.g., environmental characteristics), and so on. As shown, for a first observation, the first feature may have a value of 10 (corresponding to a difference in average interaction amounts between the particular interaction party and the selected interaction party), the second feature may have a value of 45 (corresponding to the number of common users), the third feature may have a value of 70 (corresponding to a decibel level measured at the location of the particular interaction party), and so on. These features and feature values are provided as examples, and may differ in other examples. For example, the feature set may include one or more of the following features: one or more additional aspects related to reviews of the particular interaction party and/or one or more categories (e.g., business categories and/or interaction party types) associated with the particular interaction party.

In some implementations, the observations used to train a machine learning model may be user-specific. For example, a machine learning model may be trained for and/or applied to a particular user, and the observations may be based on interactions associated with the particular user. Alternatively, the observations used to train a machine learning model may be associated with other users. For example, the observations may be based on interactions of the other users. Alternatively, the observations may be based on interactions of a subset of users, such as one or more clusters of users to which the user to whom the similar interaction parties are being recommended belongs. Thus, the recommendation system and/or the machine learning system may train multiple machine learning models for different users and/or clusters of users, and may select a machine learning model to be applied based on the user and/or a cluster to which the user belongs.

As shown by reference number 315, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 300, the target variable is a similarity score associated with a particular interaction party, which has a value of 0.9 for the first observation.

The feature set and target variable described above are provided as examples, and other examples may differ from what is described above. For example, a target variable may be a probability that the particular interaction party will be positively received by the user (e.g., as may be indicated by user feedback).

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 320, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 325 to be used to analyze new observations.

As an example, the machine learning system may obtain training data for the set of observations based on historical interactions of one or more users with multiple interaction parties. Data related to one or more of the aspects may be obtained from each interaction and/or from interaction party data associated with the interaction parties.

As shown by reference number 330, the machine learning system may apply the trained machine learning model 325 to a new observation, such as by receiving a new observation and inputting the new observation to the trained machine learning model 325. As shown, the new observation may include a first feature of a measurement of 11 related to the first aspect (e.g., average interaction amount), a second feature of a measurement of 50 related to the second aspect (e.g., number of common users), a third feature of a measure of 80 related to the third aspect (e.g., a decibel level), and so on, as an example. The machine learning system may apply the trained machine learning model 325 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 325 may predict a value of 0.9 for the target variable of a similarity score for the new observation, as shown by reference number 335. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, the similarity score for the particular interaction party. The first automated action may include, for example, transmitting data indicating the particular interaction party.

In some implementations, the recommendation system and/or the machine learning system may train and/or apply an unsupervised machine learning model, such as to cluster users. To cluster users, the observations may include demographic information and/or interaction histories of the users, among other examples. In these cases, the output of the machine learning model may include information that identifies a cluster to which a new observation belongs and/or information that indicates a degree of similarity between the new observation and one or more other observations. As an example of an unsupervised learning model, the trained machine learning model 325 may classify (e.g., cluster) the new observation in a cluster, as shown by reference number 340. The observations within a cluster may have a threshold degree of similarity. As an example, the users in the cluster of users may have the same or similar demographic information (e.g., sex, age, age range, and/or socio-economic status) or may have the same or similar pattern of interaction (e.g., interactions at similar times and/or with similar interaction parties based on the historical interaction data of the users).

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 325 may be re-trained using feedback information. For example, feedback may be provided to the machine learning model. The feedback may be associated with actions performed based on the recommendations provided by the trained machine learning model 325 and/or automated actions performed, or caused, by the trained machine learning model 325. In other words, the recommendations and/or actions output by the trained machine learning model 325 may be used as inputs to re-train the machine learning model (e.g., a feedback loop may be used to train and/or update the machine learning model). For example, the feedback information may include an indication by the user that an interaction party having a particular similarity score was not similar to the selected interaction party (e.g., via a prompt to the user on the user device).

In this way, the machine learning system may apply a rigorous and automated process to recommend interaction parties with a high level of certainty that the user will find the recommended interaction parties to be similar to the selected interaction party. The machine learning system enables recognition and/or identification of tens, hundreds, thousands, or millions of features and/or feature values for tens, hundreds, thousands, or millions of observations, thereby increasing accuracy and consistency and reducing delay associated with recommending interaction parties relative to requiring computing resources to be allocated for tens, hundreds, or thousands of operators to manually recommend interaction parties using the features or feature values.

As indicated above, FIG. 3 is provided as an example. Other examples may differ from what is described in connection with FIG. 3.

FIG. 4 is a diagram of an example environment 400 in which systems and/or methods described herein may be implemented. As shown in FIG. 4, environment 400 may include a recommendation system 410, a user device 420, a user interaction history database 430, an interaction party database 440, and a network 450. Devices of environment 400 may interconnect via wired connections, wireless connections, or a combination of wired and wireless connections.

The recommendation system 410 includes one or more devices capable of receiving, generating, storing, processing, providing, and/or routing information associated with recommending interaction parties, as described elsewhere herein. The recommendation system 410 may include a communication device and/or a computing device. For example, the recommendation system 410 may include a server, such as an application server, a client server, a web server, a database server, a host server, a proxy server, a virtual server (e.g., executing on computing hardware), or a server in a cloud computing system. In some implementations, the recommendation system 410 includes computing hardware used in a cloud computing environment.

The user device 420 includes one or more devices capable of receiving, generating, storing, processing, and/or providing information associated with recommending interaction parties, as described elsewhere herein. The user device 420 may include a communication device and/or a computing device. For example, the user device 420 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The user interaction history database 430 includes one or more devices capable of receiving, generating, storing, processing, and/or providing information associated with recommending interaction parties, as described elsewhere herein. The user interaction history database 430 may include a communication device and/or a computing device. For example, the user interaction history database 430 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the user interaction history database 430 may store interaction data indicating information associated with historical interactions of a plurality of users (e.g., date of the interactions, times of the interactions, amounts associated with the interactions, locations of the interaction, interaction types of the interactions, and/or item types of items associated with the interactions), as described elsewhere herein.

The interaction party database 440 includes one or more devices capable of receiving, generating, storing, processing, and/or providing information associated with recommending interaction parties, as described elsewhere herein. The interaction party database 440 may include a communication device and/or a computing device. For example, the interaction party database 440 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the interaction party database 440 may store interaction party data indicating information associated with a plurality of interaction parties (e.g., geographic locations associated with the interaction parties, interaction party types of the interaction parties, measurements of environmental characteristics (e.g., business traffic, noise level, and/or lighting) associated with locations of the interaction parties), reviews of the parties, and/or interaction amounts (e.g., average interaction amounts) associated with the interaction parties, as described elsewhere herein.

The network 450 includes one or more wired and/or wireless networks. For example, the network 450 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 450 enables communication among the devices of environment 400.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

FIG. 5 is a diagram of example components of a device 500, which may correspond to recommendation system 410, user device 420, user interaction history database 430, and/or interaction party database 440. In some implementations, recommendation system 410, user device 420, user interaction history database 430, and/or interaction party database 440 include one or more devices 500 and/or one or more components of device 500. As shown in FIG. 5, device 500 may include a bus 510, a processor 520, a memory 530, an input component 540, an output component 550, and a communication component 560.

Bus 510 includes one or more components that enable wired and/or wireless communication among the components of device 500. Bus 510 may couple together two or more components of FIG. 5, such as via operative coupling, communicative coupling, electronic coupling, and/or electric coupling. Processor 520 includes a central processing unit, a graphics processing unit, a microprocessor, a controller, a microcontroller, a digital signal processor, a field-programmable gate array, an application-specific integrated circuit, and/or another type of processing component. Processor 520 is implemented in hardware, firmware, or a combination of hardware and software. In some implementations, processor 520 includes one or more processors capable of being programmed to perform one or more operations or processes described elsewhere herein.

Memory 530 includes volatile and/or nonvolatile memory. For example, memory 530 may include random access memory (RAM), read only memory (ROM), a hard disk drive, and/or another type of memory (e.g., a flash memory, a magnetic memory, and/or an optical memory). Memory 530 may include internal memory (e.g., RAM, ROM, or a hard disk drive) and/or removable memory (e.g., removable via a universal serial bus connection). Memory 530 may be a non-transitory computer-readable medium. Memory 530 stores information, instructions, and/or software (e.g., one or more software applications) related to the operation of device 500. In some implementations, memory 530 includes one or more memories that are coupled to one or more processors (e.g., processor 520), such as via bus 510.

Input component 540 enables device 500 to receive input, such as user input and/or sensed input. For example, input component 540 may include a touch screen, a keyboard, a keypad, a mouse, a button, a microphone, a switch, a sensor, a global positioning system sensor, an accelerometer, a gyroscope, and/or an actuator. Output component 550 enables device 500 to provide output, such as via a display, a speaker, and/or a light-emitting diode. Communication component 560 enables device 500 to communicate with other devices via a wired connection and/or a wireless connection. For example, communication component 560 may include a receiver, a transmitter, a transceiver, a modem, a network interface card, and/or an antenna.

Device 500 may perform one or more operations or processes described herein. For example, a non-transitory computer-readable medium (e.g., memory 530) may store a set of instructions (e.g., one or more instructions or code) for execution by processor 520. Processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry is used instead of or in combination with the instructions to perform one or more operations or processes described herein. Additionally, or alternatively, processor 520 may be configured to perform one or more operations or processes described herein. Thus, implementations described herein are not limited to any specific combination of hardware circuitry and software.

The number and arrangement of components shown in FIG. 5 are provided as an example. Device 500 may include additional components, fewer components, different components, or differently arranged components than those shown in FIG. 5. Additionally, or alternatively, a set of components (e.g., one or more components) of device 500 may perform one or more functions described as being performed by another set of components of device 500.

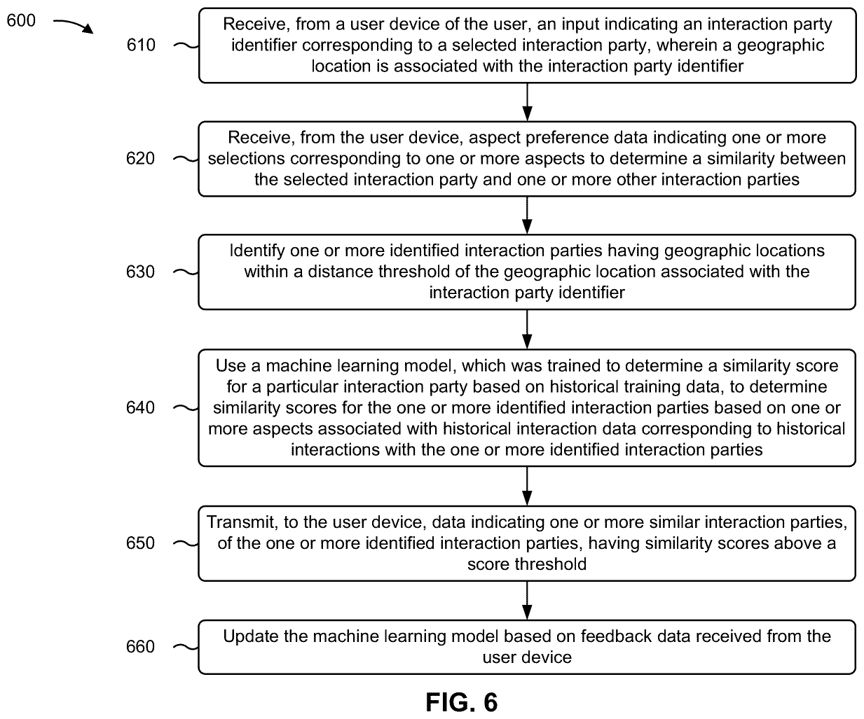

FIG. 6 is a flowchart of an example process 600 associated with a recommending interaction parties. In some implementations, one or more process blocks of FIG. 6 may be performed by the recommendation system 410. Additionally, or alternatively, one or more process blocks of FIG. 6 may be performed by one or more components of the device 500, such as processor 520, memory 530, input component 540, output component 550, and/or communication component 560.

As shown in FIG. 6, process 600 may include receiving, from a user device of the user, an input indicating an interaction party identifier corresponding to a selected interaction party, wherein a geographic location is associated with the interaction party identifier (block 610). For example, the recommendation system 410 (e.g., using processor 520, memory 530, input component 540, and/or communication component 560) may receive, from a user device of the user, an input indicating an interaction party identifier corresponding to a selected interaction party, wherein a geographic location is associated with the interaction party identifier, as described above in connection with reference number 110 of FIG. 1A. As an example, the user device may transmit, and the recommendation system may receive, data indicating the selected interaction party, which the user may select on the user device (e.g., on a map presented on a display of the user device).

As further shown in FIG. 6, process 600 may include receiving, from the user device, aspect preference data indicating one or more selections corresponding to one or more aspects to determine a similarity between the selected interaction party and one or more other interaction parties (block 620). For example, the recommendation system 410 (e.g., using processor 520, memory 530, input component 540, and/or communication component 560) may receive, from the user device, aspect preference data indicating one or more selections corresponding to one or more aspects to determine a similarity between the selected interaction party and one or more other interaction parties, as described above in connection with reference number 120 of FIG. 1A. As an example, the user device may transmit, and the recommendation system may receive, the aspect preference data indicating the preferred aspects selected by the user, which the user may select from a list (e.g., a pre-populated list) presented on the display of the user device.

As further shown in FIG. 6, process 600 may include identifying one or more identified interaction parties having geographic locations within a distance threshold of the geographic location associated with the interaction party identifier (block 630). For example, the recommendation system 410 (e.g., using processor 520 and/or memory 530) may identify one or more identified interaction parties having geographic locations within a distance threshold of the geographic location associated with the interaction party identifier, as described above in connection with reference number 125 of FIG. 1A. As an example, the recommendation system may identify all interaction parties, having geographic locations within the distance threshold, from the interaction party database, on which the interaction parties are associated with the respective geographic locations.

As further shown in FIG. 6, process 600 may include using a machine learning model, which was trained to determine a similarity score for a particular interaction party based on historical training data, to determine similarity scores for the one or more identified interaction parties based on one or more aspects associated with historical interaction data corresponding to historical interactions with the one or more identified interaction parties (block 640). For example, the recommendation system 410 (e.g., using processor 520 and/or memory 530) may use a machine learning model, which was trained to determine a similarity score for a particular interaction party based on historical training data, to determine similarity scores for the one or more identified interaction parties based on one or more aspects associated with historical interaction data corresponding to historical interactions with the one or more identified interaction parties, as described above in connection with reference number 130 of FIG. 1B. As an example, the recommendation system may use a machine learning model to determine the similarity scores based on information and data obtained from the interaction party database and/or the user interaction history database.

As further shown in FIG. 6, process 600 may include transmitting, to the user device, data indicating one or more similar interaction parties, of the one or more identified interaction parties, having similarity scores above a score threshold (block 650). For example, the recommendation system 410 (e.g., using processor 520, memory 530, and/or communication component 560) may transmit, to the user device, data indicating one or more similar interaction parties, of the one or more identified interaction parties, having similarity scores above a score threshold, as described above in connection with reference number 140 of FIG. 1B. As an example, the recommendation system may identify similar interaction parties, from the identified interaction parties, having similarity scores above the score threshold, and may transmit the data indicating the similar interaction parties to the user device, which may present information listing the similar interaction parties.

As further shown in FIG. 6, process 600 may include updating the machine learning model based on feedback data received from the user device (block 660). For example, the recommendation system 410 (e.g., using processor 520 and/or memory 530) may update the machine learning model based on feedback data received from the user device.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A, 1B, 2A, and 2B. Moreover, while process 600 has been discussed in relation to the systems and components of the preceding figures, process 600 can be performed using alternative systems, additional components, or fewer components. Process 600 should not be limited to being performed with the example systems, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for recommending interaction parties having similar aspects to an interaction party selected by a user, the system comprising:
one or more memories; and
one or more processors, communicatively coupled to the one or more memories, configured to:
receive, from a user device of the user, an input indicating an interaction party identifier corresponding to a selected interaction party, wherein a geographic location is associated with the interaction party identifier;
receive, from the user device, aspect preference data indicating one or more selections corresponding to one or more aspects to determine a similarity between the selected interaction party and one or more other interaction parties;
identify one or more identified interaction parties having geographic locations within a distance threshold of the geographic location associated with the interaction party identifier;
use a machine learning model, which was trained to determine a similarity score for a particular interaction party based on historical training data, to determine similarity scores for the one or more identified interaction parties based on one or more aspects associated with historical interaction data corresponding to historical interactions with the one or more identified interaction parties;
transmit, to the user device, data indicating one or more similar interaction parties, of the one or more identified interaction parties, having similarity scores above a score threshold; and
update the machine learning model based on feedback data received from the user device.

2. The system of claim 1, wherein the one or more aspects includes average interaction amounts associated with the one or more identified interaction parties.

3. The system of claim 2, wherein the one or more processors, to determine the similarity scores, are configured to:
determine differences between the average interaction amounts associated with the one or more identified interaction parties and an average interaction amount associated with the selected interaction party.

4. The system of claim 1, wherein the one or more aspects includes common users between the selected interaction party and the one or more identified interaction parties.

5. The system of claim 4, wherein the one or more processors, to determine the similarity scores, are configured to:
identify, from a plurality of records of historical interactions of a plurality of users stored on a user interaction history database, a shared number corresponding to one or more users, of the plurality of users, having interactions with the selected interaction party and one or more of the identified interaction parties; and
identify, from the plurality of records of historical interactions, a total number of users, of the plurality of users, having interactions with either of the selected interaction party and the one or more of the identified interaction parties,
wherein the similarity scores are based at least in part on a comparison of the shared number and the total number.

6. The system of claim 1, wherein the one or more aspects includes one or more environmental characteristics associated with the one or more identified interaction parties.

7. The system of claim 6, wherein the one or more processors, to determine the similarity scores, are configured to:
determine measures corresponding to the one or more environmental characteristics associated with the one or more identified interaction parties; and
determine a measure corresponding to the one or more environmental characteristics associated with the selected interaction party,
wherein the similarity scores are based at least in part on a comparison of the measures associated with the one or more identified interaction parties and the measure associated with the selected interaction party.

8. The system of claim 1, wherein the one or more aspects includes reviews associated with the one or more identified interaction parties.

9. The system of claim 8, wherein the similarity scores are based at least in part on a comparison of the reviews associated with the one or more identified interaction parties and reviews associated with the selected interaction party.

10. The system of claim 1, wherein the one or more identified interaction parties are associated with one or more categories of a plurality of categories, and
wherein the one or more aspects includes the plurality of categories.

11. The system of claim 10, wherein the one or more processors, to determine the similarity scores, are configured to:
determine one or more common categories, of the plurality of categories, between the one or more identified interaction parties and the selected interaction party,
wherein the similarity scores are based at least in part on a number of common categories.

12. A method of recommending interaction parties having similar aspects to an interaction party selected by a user, comprising:
identifying, by a system that includes at least one processor and from historical interaction data of a user stored in a database, a selected interaction party from a historical interaction by the user;
determining, by the system, a geographic location associated with a user device of the user;
identifying, by the system, one or more identified interaction parties having geographic locations within a distance threshold of the geographic location associated with the user device of the user;
determining, by the system, similarity scores for the one or more identified interaction parties, wherein the similarity scores are based at least in part on the one or more aspects; and
transmitting, by the system and to the user device, data indicating one or more similar interaction parties, of the one or more identified interaction parties, having similarity scores above a score threshold.

13. The method of claim 12, wherein determining the similarity scores for the one or more identified interaction parties comprises:
using a machine learning model, which was trained to determine a similarity score for a particular interaction party based on historical training data, to determine the similarity scores for the one or more identified interaction parties based on the one or more aspects associated with the historical interaction data corresponding to historical interactions with the one or more identified interaction parties.

14. The method of claim 13, further comprising:
updating the machine learning model based on feedback data received from the user device.

15. The method of claim 12, wherein the one or more aspects include at least one of:
average interaction amounts associated with the one or more identified interaction parties,
a number of common users shared by the one or more identified interaction parties and the selected interaction party,
one or more environmental characteristics associated with the one or more identified interaction parties,
one or more reviews associated with the one or more identified interaction parties, or
one or more categories associated with the one or more identified interaction parties.

16. The method of claim 12, wherein the similarity score is determined based at least in part on a comparison of the one or more aspects associated with the one or more identified interaction parties and the one or more aspects associated with the selected interaction party.

17. A non-transitory computer-readable medium storing a set of instructions, the set of instructions comprising:
one or more instructions that, when executed by one or more processors of a device, cause the device to:
receive, from a user device of a user, an input indicating an interaction party identifier corresponding to a selected interaction party, wherein a geographic location is associated with the interaction party identifier;
receive, from the user device, aspect preference data indicating one or more selections corresponding to one or more aspects to determine a similarity between the selected interaction party and one or more other interaction parties;
identify one or more identified interaction parties having geographic locations within a distance threshold of the geographic location associated with the interaction party identifier;
determine similarity scores for the one or more identified interaction parties, wherein the similarity scores are based on the one or more aspects; and
transmit, to the user device, data indicating one or more similar interaction parties, of the one or more identified interaction parties, having similarity scores above a score threshold.

18. The non-transitory computer-readable medium of claim 17, wherein the one or more instructions further cause the device to:
use a machine learning model, which was trained to determine a similarity score for a particular interaction party based on historical training data, to determine the similarity scores for the one or more identified interaction parties based on the one or more aspects associated with historical interaction data corresponding to historical interactions with the one or more identified interaction parties; and
update the machine learning model based on feedback data received from the user device.

19. The non-transitory computer-readable medium of claim 17, wherein the one or more aspects include at least one of:
average interaction amounts associated with the one or more identified interaction parties,
a number of common users shared by the one or more identified interaction parties and the selected interaction party,
one or more environmental characteristics associated with the one or more identified interaction parties,
one or more reviews associated with the one or more identified interaction parties, or
one or more categories associated with the one or more identified interaction parties.

20. The non-transitory computer-readable medium of claim 17, wherein the similarity score is determined based at least in part on a comparison of the one or more aspects associated with the one or more identified interaction parties and the one or more aspects associated with the selected interaction party.
